(19) United States
(12) Patent Application Publication
(10) Pub. No.: US 2005/0050042 A1
(43) Pub. Date: Mar. 3, 2005

(54) Natural language database querying

(76) Inventor: Marvin Elder, Carrollton, TX (US)

Correspondence Address: Steven Thrasher, 391 Sandhill Dr., Richardson, TX, 75080, US

(21) Appl. No.: 10/923,394

(22) Filed: Aug. 20, 2004

Related U.S. Application Data
(60) Provisional application No. 60/496,442, filed on Aug. 20, 2003.

(51) Int. Cl. G06F 7/00

(52) U.S. Cl. 707/4

(57) ABSTRACT

The invention teaches preparing data sources for a natural language query. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS REFERENCE TO RELATED APPLICATIONS

The invention is a continuation in part of, is related to, and claims priority from U.S. Provisional Patent Application No. 60/496,442, filed on Aug. 20, 2003, by Marvin Elder, and entitled NATURAL LANGUAGE PROCESSING SYSTEM METHOD AND APPARATUS.

### TECHNICAL FIELD OF THE INVENTION

The invention relates generally to matching data in data sources with data queries.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

The ability to quickly and effectively access data is important to individuals, business and the government. Individuals often use spreadsheets to access specific data regarding items such as checking accounts balances, and cooking recipes. Businesses' thrive off of effective access of data of all kinds including, shipping delivery, inventory management, financial statements, and a world of other uses. In addition to managing revenue flow, the government utilizes data access for purposes ranging from artillery tables, to fingerprint data bases, to terrorist watch lists, and the mountain of statistics and information compiled by the census bureau.

Of course, there are literally millions different kinds of data source accesses known by persons in their every day lives, as well as by professionals in data storage and access arts. Unfortunately, it frequently takes some degree of familiarity with database searching structure to effectively access data in a data source, such that there are actually specialists in searching various data sources for specific types of information. Accordingly, there is a need for systems, methods, and devices that enable a person who does not have formal training to effectively search data sources.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 illustrates a natural language request algorithm.

FIG. 2 shows a natural automated answer delivery algorithm.

FIG. 3 is an enable natural language algorithm.

FIG. 4 illustrates a natural language linking algorithm.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

Description of the Drawings

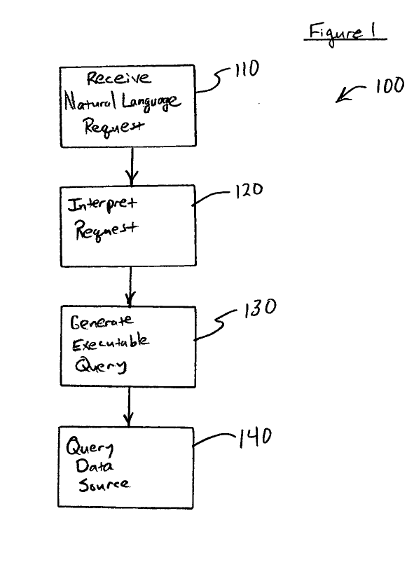

FIG. 1 illustrates a natural language request algorithm (NLR Algorithm) 100 that is preferably performed on a dataset that has already been through Semantification (discussed below). The NLR algorithm 100 begins with a receive natural language request 110. A NLR generally comprising text (either written or vocalized), where the text generally comprises phrases having words. The request may be in English, Spanish, Japanese, French, German, or any other language for which rules sets are available. What distinguishes a NLR from a typical data based structured query is that a NLR is made in the users' vernacular language—that a query may be formulated without strict adherence to definitions and/or rules of grammar.

Accordingly, a person without any formal database training should be able to make a query that is interpretable and results in the delivery in of data and response to that query as described herein. Of course, it should be understood that other means of receiving a NLR other than type written text or vocalized text, such as through object oriented or icon driven query, touch tone or touch tone responses across a telephone network, and equivalents including those known and unknown. Next, in an interpret request act 120, the NLR algorithm 100 classifies each word according to a rule set based on language rules that identify parts of speech. For example, words may be identified as verbs, subject, and direct or indirect objects. One system that accomplishes this task, sometimes referred to as parsing, is the Sementra™ discussed below.

Following the interpret request act 120, the NLR algorithm 100 proceeds to a generate executable query act 130. The generate executable query act 130 creates a query statement readable by a standard structured query language or other structured data base system based on the association of each word with a part of speech. Accordingly, the natural language query or question entered by a user is best converted to structured code that can formally query a data base or other data source, such as a spreadsheet, indexed text, or other equivalent data storage system, known or unknown. Then, when a query data source act 140, the structured data base query is sent to the data source. If data matching the data query exists in the data source, that data is extracted from the data source. The extracted data is defined as a result set.

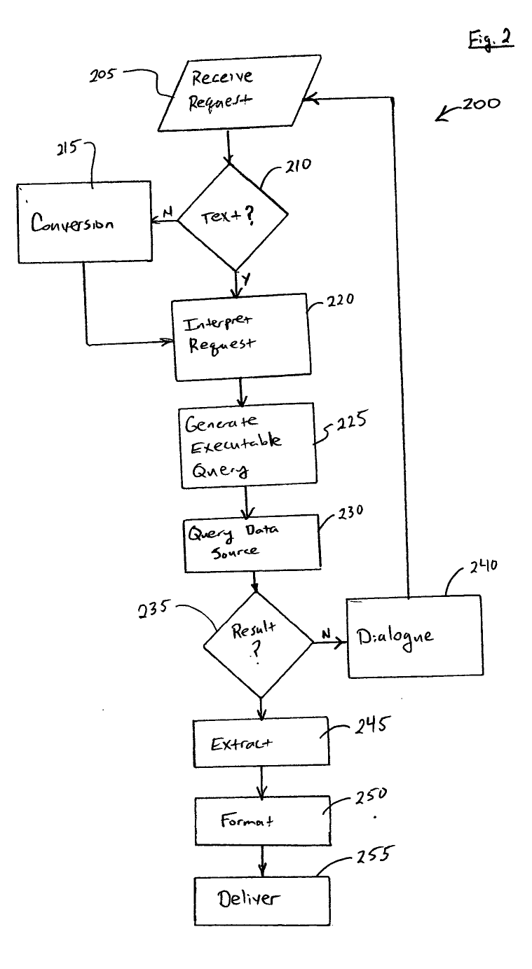

FIG. 2 shows a natural language automated answer delivery algorithm (NLA algorithm) 200. The NLA algorithm 200 performs the task identified in the receive NLR 110 of the NLR algorithm 100. Then, the NLA algorithm 200 proceeds to a text query 210 which checks the received request to determine if a conversion from voice to text or touch-tone to text or icon to text or other conversion is necessary. If the text query 210 determines that the received request does not consist of written words, the NLA algorithm 200 proceeds along the no path to a conversion at 215. In the conversion act 215 the received request is converted into a text request. For example, an icon of a ship may be converted into the word ship, a touch-tone that sounds as 3 may be converted into service department, or the vocalized query may be converted to text through voice to text technology.

If the text query 210 determines that no conversion is necessary the NLA algorithm 200 proceeds along the yes path to an interpret request act 220. The interpret request act 220 is also reached following the conversion act 215. The interpret request act 220 performs the task of the interpret request act 120 of the NLR algorithm 100 before proceeding to a generate executable query act 225, which mirrors the generate executable query act 130 of the NLR algorithm 100. Interpreting the request may also comprise pursing the text by referencing a Symantec phrase or repository, and may locate noun phrases in a conceptual object repository. Further a user may add references in a Semantic phrase repository or in a conceptual object repository to aid in a full and accurate interpretation of the request.

Then, the structured query is sent to a data source in a query data source act 230 in an attempt to find the desired information. Of course, the information may be present, but the natural language query provided may be too ambiguous or broad or alternatively too narrow to pin point that information. Accordingly, following the query data source act 230 a result query 235 is performed. The result query 235 prompts the user to see if the result generated matches the data sought. If the result generated (including no result at all) is not what was sought, the NLA algorithm 200 proceeds along a no path to a dialogue at 240.

The dialogue 240 prompts the user to enter additional or different query requests in an attempt to provide better search results. In one embodiment, the request will prompt a user regarding whether or not one word is equivalent to another word, and/or one word is a sub-set or super-set of a word or phrase. However, if in the result query 235 results are received, then the NLA algorithm 200 proceeds along the yes path to an extract act 245. The extract act 245 copies the data from the data sources and presents that data to the user in a user identifiable format that may include written text, audible report, or icons, for example. In addition, the NLA algorithm 200 may also format the search results in either a pre defined or in a user selective manner.

For example, a data report may be formatted as a cable, or the data may be converted into a natural language response. Of course many different forms of presenting data are available, and equivalents known and unknown are incorporated within the scope of the invention. Then, following the formatting of the search results, the search results are delivered to the user making the query in a deliver act 255.

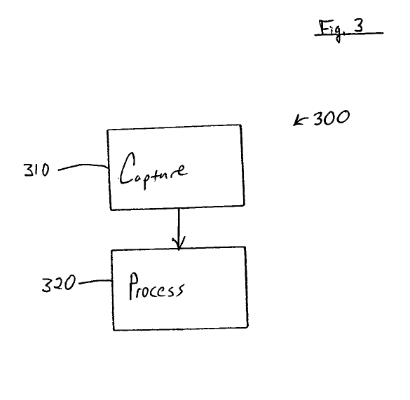

FIG. 3 shows an enabled natural language algorithm (ENL algorithm) 300. The ENL algorithm 300 begins with a capture act 310 in which the metadata associated with a target data source, such as a database spreadsheet XML file a web service or an RSS type web service, for example, is captured. The metadata in one embodiment defines a target concept model. Then, in a process act 320 the ENL algorithm 300 processes the target concept model to enable data base searching through natural language queries. Capturing may include the process of building a concept data model by generating a first concept object from a data source, a link that associates a first element to a second element in a logical association, and a natural language identifier that uniquely names the target concept model via at least one natural word.

Target concept models may comprise entities, and each entity should be logical mapped to a table in a target data source. In addition, each entity comprises at least one attribute and each attribute should be logically mapped to one column in the table.

The target concept model may also define a subject area. While a subject area includes one or more logical views, Similarly, a logical view includes at least two entities. Further, each entity and each attribute should be assigned a unique natural language name.

Processing includes generating a semantic phrase that associates at least two entities, or at least two attributes. The semantic phrase is then stored in a semantic phrase or repository. In one embodiment, a second semantic phrase may be linked to the first semantic phrase in a parent child relationship (the parents semantic phrase already exists in a semantic phrase repository). In addition, processing may add a new concept model layer to an existing concept model repository, and also may add one or more semantic phrases to an existing semantic phrase repository where the two repositories are interdependent. The two semantic phrase repositories are structured and organized such that a natural language request for information from a target data base can be interpreted by a natural language processor and automatically translated into a data query that returns a precise answer.

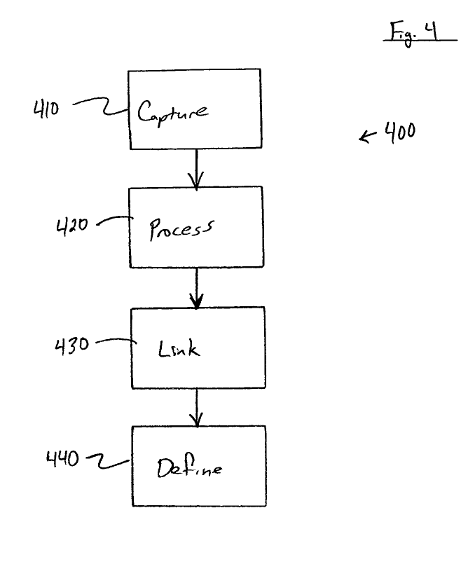

FIG. 4 illustrates a natural language linking algorithm (NLL algorithm) 400. In addition to capturing 410 and processing 320 the NLL algorithm 400 also defines a logical relationship between a pair of entities and a target concept model in a linking act 430. In one embodiment this is based on metadata. In an alternative embodiment the linking of two entities is based upon a logical relationship that includes ‘is-a’‘ has-a’ and ‘member-of’ relationships.

Then in a define act 440 a concept object is defined based on conditions that make the concept object unique. In addition, the define act 440 may define a new attribute as a logical equivalent of a pre-defined attribute associated with an entity.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. It is therefore the intention that the appended claims and their equivalents be interpreted as broadly as possible in view of the prior art to include all such variations and modifications.

1. A method, comprising, sequentially:
receiving a natural language request, the natural language request being convertible to text comprising at least one phrase, where the phrase comprises at least one word;
interpreting the request by classifying each word or phrase according to a rules set based on language rules that identify the parts of speech;
generating an executable database query based on the classified word or phrase; and
sending the database query to a data source.

2. The method of claim 1 further comprising extracting a result set from the data source.

3. The method of claim 2 further comprising formatting the answer to the database query for user presentation.

4. The method of claim 3 further comprising delivering an answer to the database query.

5. The method of claim 3 wherein formatting places the answer that comprises data in a table format.

6. The method of claim 3 wherein formatting places the answer that comprises data in a natural language format.

7. The method of claim 1 wherein the natural language request is made in English.

8. The method of claim 1 wherein the database query is an SQL database query.

9. The method of claim 1 wherein the natural language request does not impose a strict syntax structure on the user

10. The method of claim 1 wherein the natural language request does not impose a strict word definition requirement on the user.

11. The method of claim 1 wherein interpreting the request comprises parsing the text by referencing a Semantic Phrase Repository.

12. The method of claim 11 further comprising locating noun phrases in a Conceptual Object Repository.

13. The method of claim 12 further comprising generating a clarification dialog if the database query fails to match all of the phrases in the request with references either in a Semantic Phrase Repository or in a Conceptual Object Repository.

14. The method of claim 13 further comprising allowing the user to add references in a Semantic Phrase Repository or in a Conceptual Object Repository to produce an accurate interpretation of the request.

15. The method of claim 1 wherein the natural language request is received as audible speech, and then converting speech to text prior to interpreting the request.

16. The method of claim 15 further comprising assisting a speech to text conversion application in disambiguating speech objects by providing a reference in a Semantic Phrase Repository or in a Conceptual Object Repository.

17. A machine-readable memory storage device that enables a user to perform natural language database searches, by sequentially:
receiving a natural language request, the natural language request being convertible to text comprising at least one phrase, where the phrase comprises at least one word;
interpreting the request by classifying each word or phrase according to a rules set based on language rules that identify the parts of speech;
generating an executable database query based on the classified word or phrase;
sending the database query to a data source, and
extracting a result set from the data source.

18. A specific computing device that enables a user to perform natural language database searches, by sequentially:
receiving a natural language request, the natural language request being convertible to text comprising at least one phrase, where the phrase comprises at least one word;
interpreting the request by classifying each word or phrase according to a rules set based on language rules that identify the parts of speech;
generating an executable database query based on the classified word or phrase;
sending the database query to a data source, and
formatting the answer to the database query for user presentation.
